(19) United States
(12) Patent Application Publication
(10) Pub. No.: US 2014/0180740 A1
(43) Pub. Date: Jun. 26, 2014

(54) SYSTEM AND METHOD FOR ASSET ASSIGNMENT IN A SERVICE DELIVERY ENVIRONMENT WHEN ASSETS HAVE UNIQUE SKILLS AND/OR CAPABILITIES

(71) Applicant: INTERNATIONAL BUSINESS MACHINES CORPORATION, Armonk, NY (US)

(72) Inventors: Gargi B. Dasgupta, Gurgaon (IN); Nirmit V. Desai, Bangalore (IN); Yixin Diao, White Plains, NY (US); Aliza R. Heching, Bronx, NY (US)

(73) Assignee: International Business Machines Corporation, Armonk, NY (US)

(21) Appl. No.: 13/777,496

(22) Filed: Feb. 26, 2013

Related U.S. Application Data
(63) Continuation of application No. 13/723,609, filed on Dec. 21, 2012.

(51) Int. Cl. G06Q 10/06

(52) U.S. Cl. CPC G06Q 10/063112
USPC 705/7.14

(57) ABSTRACT

Systems and methods for determining asset assignment in a service delivery environment are provided. A method for asset assignment in a service delivery environment, comprises identifying a number of worktypes, defining a plurality of asset resource pools and identifying a number of the resource pools, calculating a uniqueness of each resource pool, computing a utilization of each resource pool, and determining a uniqueness adjusted utilization value for each resource pool, wherein one or more steps of the method are performed by a computer system comprising a memory and at least one processor coupled to the memory.

### CROSS-REFERENCE TO RELATED APPLICATION

This application is a Continuation of U.S. application Ser. No. 13/723,609, filed on Dec. 21, 2012, the disclosure of which is incorporated herein in its entirety by reference.

### TECHNICAL FIELD

The field generally relates to systems and methods for asset assignment in a service delivery environment and, in particular, to systems and methods for asset assignment in a service delivery environment which consider the uniqueness of assets' skills and/or capabilities and asset utilization.

### BACKGROUND

Service delivery can refer to proactive services that are delivered to provide adequate support to business users. Services may be provided from a variety of sources, including but not limited to, Internet and network service providers, and may include general business services, such as, for example, accounting, payroll, data management, and computer type services, such as, for example, information technology (IT) and cloud services. A service delivery environment includes, for example, a team or group of assets with one or multiple skills and/or capabilities relating the delivered services, wherein the assets provide services to support the customers that require one or multiple levels of skills and/or capabilities.

A service provider endeavors to assign assets with the proper skill sets and/or capabilities to deliver the requested services and meet customer requirements while achieving one or more objectives such as low or minimum cost (other objectives can be, for example, maximum profit, high customer satisfaction, etc.). Higher asset utilization, for example, assigning an asset to any task for which the asset has the skills and/or capabilities to respond, can lead to reduced cost. However, a challenge arises when an asset with unique skills and/or capabilities for a specific task is not available to perform the task because the asset is already responding to another request which may not have required the unique skill set. For example, it can be inefficient to interrupt and reassign the asset with the unique skills and/or capabilities to the request requiring the unique skill set and/or capabilities while that asset is responding to another service request. Such an interruption may not be possible under the terms of a service level agreement (SLA), and/or may increase cost and response time due to the need to bring a new asset up to speed on the work already performed, or the need to remove and replace an asset in the middle of responding to a service request, which may require additional setup time in the case of machines, to set up the job on the replacement asset. Further, agents with unique skills can be under-utilized if those agents are saved for or limited to requests that require their specialized skills and/or capabilities.

Known methods for assignment of assets, such as, round robin (e.g., balancing workload across assets), and fixed queue ratio (e.g., balancing queue lengths for different request queues to meet service level objectives (SLOs)), fail to address the considerations of reserving the unique skills and/or capabilities of assets without driving down asset utilization.

Accordingly, there is a need for methods and systems for asset assignment which balance the demands for high asset utilization and reserving an asset for tasks which the asset is uniquely skilled and/or capable to handle.

### SUMMARY

In general, exemplary embodiments of the invention include systems and methods for determining asset assignment in a service delivery environment and, in particular, to systems and methods for determining asset assignment in a service delivery environment which consider the uniqueness of assets' skills and/or capabilities and asset utilization.

According to an exemplary embodiment of the present invention, a system for determining asset assignment in a service delivery environment comprises a worktype module capable of processing worktype data to define a plurality of worktypes and identify a number of the worktypes, a resource pool module connected with the worktype module, wherein the resource pool module receives the processed worktype data from the worktype module and is capable of using the processed worktype data and asset ability data to define a plurality of asset resource pools and identify a number of the resource pools, a uniqueness module connected with the resource pool module, wherein the uniqueness module receives resource pool data from the resource pool module and is capable of calculating a uniqueness of each resource pool, a utilization module connected with the resource pool module, wherein the utilization module receives the resource pool data from the resource pool module and is capable of computing a utilization of each resource pool, and a ranking module connected with the utilization and uniqueness modules, wherein the ranking module receives the uniqueness and the utilization of each resource pool from the uniqueness and utilization modules, and determines a uniqueness adjusted utilization value for each resource pool, wherein one or more of the modules are implemented on a computer system comprising a memory and at least one processor coupled to the memory.

The resource pool module may use the asset ability data to determine affinity vectors for each asset, and may analyze the asset affinity vectors to define and identify the number of the asset resource pools. The resource pool data may include assets in each resource pool and the number of resource pools.

The uniqueness module may receive the processed worktype data, and wherein, for each worktype, the uniqueness module counts a number of resource pools that can process the worktype, and defines a uniqueness of each worktype. The uniqueness module may define the uniqueness of each worktype as 1/x, where x is the number of resource pools that can process the worktype. The uniqueness module may calculate the uniqueness of each resource pool by summing the uniquenesses of each worktype handled by a resource pool.

The utilization module may use utilization data collected for each resource pool to compute the utilization of each resource pool to a current time. According to an embodiment, the time may be a utilization to date of each resource pool, or a utilization to a current simulation time. The utilization of each resource pool may be computed by calculating a total time period that assets from a resource pool have been used over an overall time period.

The ranking module may determine the uniqueness adjusted utilization value for each pool by multiplying the uniqueness of a resource pool by the utilization of the resource pool.

The ranking module may order the resource pools in order of uniqueness adjusted utilization value. The order can be, for example, ascending or descending.

The system may further comprise an assignment module capable of determining which of the resource pools have an affinity for a work request, and assigning the work request to a first ranked resource pool that has the affinity for the work request. Depending on whether the order is ascending or descending, first ranked may refer to highest or lowest ranked.

According to an exemplary embodiment of the present invention, a method for asset assignment in a service delivery environment, comprises identifying a number of worktypes, defining a plurality of asset resource pools and identifying a number of the resource pools, calculating a uniqueness of each resource pool, computing a utilization of each resource pool, and determining a uniqueness adjusted utilization value for each resource pool, wherein one or more steps of the method are performed by a computer system comprising a memory and at least one processor coupled to the memory.

A resource pool may include a group of assets who have identical affinity vectors.

The method may further comprise collecting asset ability information, and defining affinity vectors for each asset.

The method may further comprise for each worktype, counting a number of resource pools that can process the worktype, and defining a uniqueness of each worktype.

The uniqueness of each worktype may be defined as 1/x, where x is the number of resource pools that can process the worktype. Calculating the uniqueness of each resource pool may comprise summing the uniquenesses of each worktype handled by a resource pool.

The method may further comprise collecting utilization data for each resource pool and using the utilization data to compute the utilization of each resource pool to a current time. Computing the utilization of each resource pool may comprise calculating a total time period that assets from a resource pool have been used over an overall time period.

Determining the uniqueness adjusted utilization value for each pool may comprise multiplying the uniqueness of a resource pool by the utilization of the resource pool.

The method may further comprise ordering the resource pools in order of uniqueness adjusted utilization value, determining which of the resource pools have an affinity for a work request, and assigning the work request to a first ranked resource pool that has the affinity for the work request.

According to an exemplary embodiment of the present invention, an article of manufacture comprises a computer readable storage medium comprising program code tangibly embodied thereon, which when executed by a computer, performs method steps for asset assignment in a service delivery environment, the method steps comprising identifying a number of worktypes, defining a plurality of asset resource pools and identifying a number of the resource pools, calculating a uniqueness of each resource pool, computing a utilization of each resource pool, and determining a uniqueness adjusted utilization value for each resource pool.

According to an exemplary embodiment of the present invention, an apparatus for determining asset assignment in a service delivery environment, comprises a memory, and a processor coupled to the memory and configured to execute code stored in the memory for identifying a number of worktypes, defining a plurality of asset resource pools and identifying a number of the resource pools, calculating a uniqueness of each resource pool, computing a utilization of each resource pool, and determining a uniqueness adjusted utilization value for each resource pool.

These and other exemplary embodiments of the invention will be described or become apparent from the following detailed description of exemplary embodiments, which is to be read in connection with the accompanying drawings.

### BRIEF DESCRIPTION OF THE DRAWINGS

Exemplary embodiments of the present invention will be described below in more detail, with reference to the accompanying drawings, of which:

FIG. 1 is a flow diagram of a method for determining asset assignment in a service delivery environment according to an exemplary embodiment of the invention.

FIG. 2 is a flow diagram of a method for defining asset resource pools according to an exemplary embodiment of the invention.

FIG. 3 is a high-level diagram of a system for determining asset assignment in a service delivery environment according to an exemplary embodiment of the invention.

FIG. 4 illustrates a computer system in accordance with which one or more components/steps of the techniques of the invention may be implemented, according to an exemplary embodiment of the invention.

### DETAILED DESCRIPTION OF EXEMPLARY EMBODIMENTS

Exemplary embodiments of the invention will now be discussed in further detail with regard to systems and methods for determining asset assignment in a service delivery environment and, in particular, to systems and methods for determining asset assignment in a service delivery environment which consider the uniqueness of assets' skills and/or capabilities and asset utilization. This invention may, however, be embodied in many different forms and should not be construed as limited to the embodiments set forth herein.

Assets as used herein can refer to any asset or set of assets, and configurations thereof, that are used to contribute to delivering a service and/or responding to one or more service requests. Assets may have one or more attributes that are used to meet the needs of a customer. According to embodiments, a customer may be a physical customer or a request, e.g., a job/customer request, requiring a service and/or response to a service request. For example, assets may include computer applications and application attributes, e.g., a payroll function; equipment and attributes of equipment capability related to the service; a knowledge-base with particular attributes (e.g., search index); and/or a staffing configuration, which is a configuration of one or more service agents for delivering one or more of such services and/or responding to one or more service requests. A configuration of assets can include one or more assets of different types with different attributes used to deliver the requested services and/or responses.

According to embodiments of the present invention, a method of scoring assets (e.g., service agents, equipment, computer applications, etc.) to determine asset priority for assigning requests balances between two conflicting objectives: (1) a desire to increase utilization, which encourages assignment of requests to the first available asset; and (2) avoidance of inefficiency associated with switching between service requests, which encourages reserving assets with unique skills and/or capabilities.

According to embodiments of the present invention, an overall asset score is determined as a function of at least two components: (1) a uniqueness score, which is determined based upon the number of unique skills and/or capabilities an asset possesses; and (2) a utilization score, which is determined based upon asset utilization up to a specified date, such as, for example, the day on which the request is assigned to an asset. According to an embodiment, the overall asset score is recomputed each time a task is available for assignment.

The components of the asset score can be one-time determinations or updated at different frequencies. For example, according to an embodiment, computations of uniqueness scores for assets may be one-time activities, where the unique skills and/or capabilities of each asset are identified, and a score is assigned to each of the assets according to the number of unique skills and/or capabilities the asset possesses. Computation of utilization scores is performed at predetermined times, for example, prior to assignment of a new task. Unlike uniqueness scores, which may remain static if the assets do not acquire new skills and/or capabilities, or the set of assets does not change, utilization is a dynamic value which changes each time an asset is assigned to a new task. Accordingly, the utilization score must be updated to track utilization of each asset as time progresses. Additionally, to the extent necessary, if, for example, assets are known to have acquired new skills and/or capabilities, due to for example, additional training, education, programs or applications, uniqueness scores may also be updated.

In general, according to embodiments of the present invention, once overall scores per asset are determined, each asset is scored for priority to receive requests by combining the asset's uniqueness and utilization scores. In other words, the overall asset scores are used to order assets to search for the first possible asset to whom or to which a request will be assigned. For example, incoming requests will be assigned to the first feasible asset. The first feasible asset is the asset with the highest ranking (based on overall score) that also has the required skills and/or capabilities to complete the request. According to an embodiment, each incoming request is tagged with skills and/or capabilities required to complete the request.

In accordance with an embodiment of the present invention, as an alternative to ranking or ordering assets as individuals, asset resource pools, which each include those assets capable of supporting the same requests, are scored for uniqueness and utilization and ranked. Therefore, incoming requests can be assigned the first feasible resource pool, and any available asset in the resource pool can be used to fulfill the request.

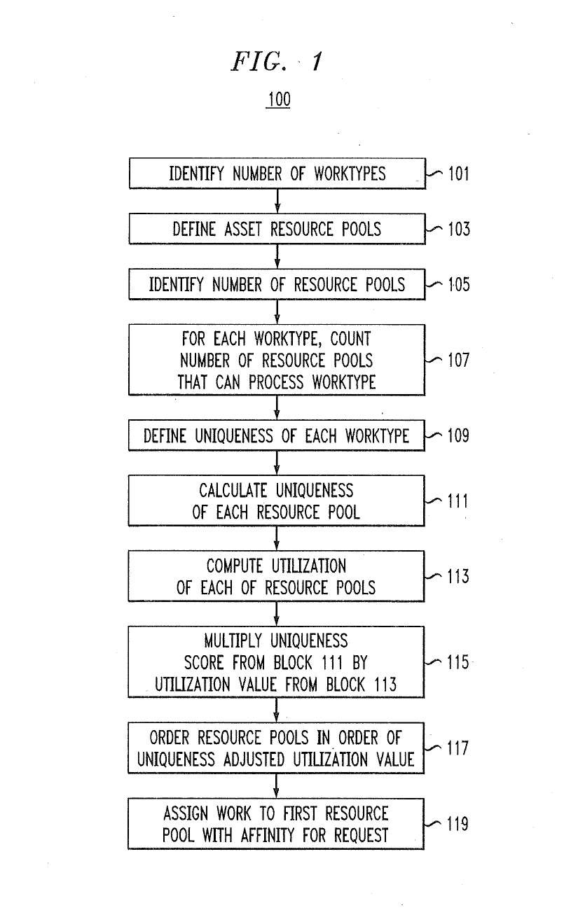

Referring to FIG. 1, which is a flow diagram of a method for determining asset assignment in a service delivery environment, according to an embodiment of the present invention, the number of worktypes W is identified at block 101, asset resource pools are defined at block 103, and the number of resource pools N is identified at block 105. According to an embodiment, an asset resource pool refers to a group of assets who have identical affinity vectors, wherein an asset's affinity vector is 0-1 vector indicating the requests/worktypes that the asset is capable of supporting, where 0 indicates “cannot support” and 1 indicates “can support”. An asset has an affinity for a request/worktype if the asset is able to respond to the request.

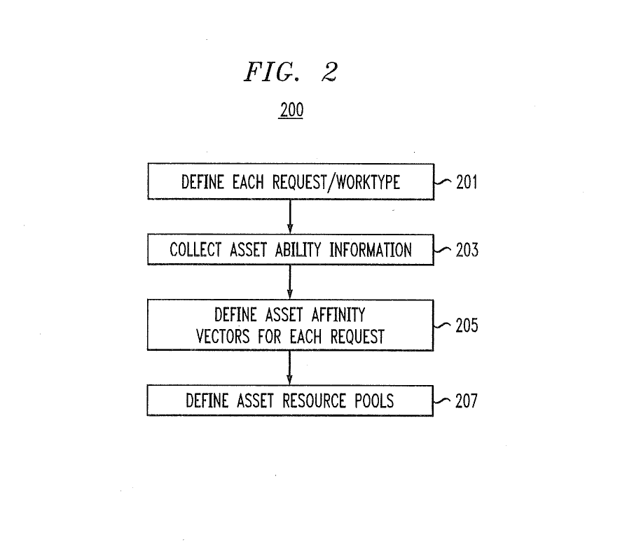

FIG. 2 is a flow diagram of a method for defining asset resource pools, according to an embodiment of the present invention. Referring to FIG. 2, each request/worktype 1, . . . , W is defined at block 201, asset ability (e.g., skill/capability) information is collected at block 203, and asset affinity vectors for each request are defined at block 205. For example, assuming there are four (4) request types, 1, 2, 3, 4, and Asset 1 has the skills/capabilities to support requests 1, 2, 3, Asset 2 has the skills/capabilities to support requests 1, 3, Asset 3 has the skills/capabilities to support requests 1, 2, 3, 4 and Asset 4 has the skills/capabilities to support requests 1, 3. Therefore, the assets' affinity vectors are set forth in Table 1.

TABLE 1

| Asset | Requests Asset Can Support | Affinity Vector |
|---|---|---|
| 1 | 1, 2, 3 | {1, 1, 1, 0} |
| 2 | 1, 3 | {1, 0, 1, 0} |
| 3 | 1, 2, 3, 4 | {1, 1, 1, 1} |
| 4 | 1, 3 | {1, 0, 1, 0} |

Then, at block 207, the asset affinity vectors are analyzed to define the asset resource pools. In this example, with the understanding that an asset resource pool is defined as a group of assets who have identical affinity vectors, there are three (3) asset resource pools including Pool 1 with Assets 2 and 4, Pool 2 with Asset 1 and Pool 3 with Asset 3. Referring back to FIG. 1, the number of resource pools N is identified at block 105 (in this example N=3). Then, at block 107, for each request/worktype, the number of resource pools that can process that worktype is counted. For example, in the case of the above example, letting x be the number of resource pools that can process a worktype, x=3 for request 1 (all pools can support), x=2 for request 2 (2 pools can support), x=3 for request 3 (all pools can support) and x=1 for request 4 (1 pool can support). At block 109, the uniqueness of each worktype/request is defined as 1/x or 1/3 for requests 1 and 3, 1/2 for request 2 and 1/1 for request 4. As can be seen, request/worktype 4 has the highest uniqueness since the least number of pools are able to support this request/worktype.

Next, at block 111, the uniqueness of each resource pool is calculated. The uniqueness of a resource pool is a function of the number of unique worktypes that the pool can handle. For example, if the pool only handles worktypes that are handled by all pools, then this pool is not unique. However, if a resource pool handles many unique worktypes, then this is a unique pool. The embodiments of the present invention attempt to minimize the likelihood that the resources of this unique pool are assigned to tasks that any pool can handle.

The uniqueness of a pool is computed as the sum of the uniqueness of each of the worktypes handled by the pool. For example, in the case of the above example, the uniqueness of Pool 1 is equal to the sum of the uniqueness of request/worktypes 1 and 3 or 1/3+1/3=2/3. The uniqueness of Pool 2 is equal to the sum of the uniqueness of request/worktypes 1, 2 and 3 or 1/3+1/2+1/3=7/6, and the uniqueness of Pool 3 is equal to the sum of the uniqueness of request worktypes 1, 2, 3 and 4 or 1/3+1/2+1/3+1=13/6. Because the affinity vector is identical for all assets in a pool, the uniqueness of the assets in each pool is equal to the uniqueness of the pool in which the assets are found.

At block 113, the utilization of each of the resource pools is computed to a current time by calculating a total time period that assets from a resource pool have been used over an overall time period. For example, if 4 hours have elapsed and assets from a first pool have been utilized for a total of 1 hour and assets from a second pool have been utilized for a total of 2 hours, the second pool has a 50% utilization, while the first pool has a 25% utilization. As time continues and more work is assigned, the utilization scores are updated to reflect new values of elapsed time and the time each resource pool has spent working. The time up until which the utilization is calculated can be, for example, a utilization to date of each resource pool, or a utilization to a current simulation time.

Then at block 115, the resource pool uniqueness score from block 111 is multiplied by the utilization value from block 113 to determine a uniqueness adjusted utilization value. At block 117, the resource pools are ordered in order of uniqueness adjusted utilization value, and at block 119 work is assigned to the first ranked resource pool that has an affinity for (i.e., is capable of supporting) the request. According to an embodiment, the resource pools can be ordered in ascending or descending order of uniqueness adjusted utilization value, and a first ranked resource pool can be the highest or lowest ranked resource pool depending on how the resource pools are ordered. According to an embodiment, if no assets in the first ranked resource pool are available to complete the work order, the process moves the next ranked resource pool with an affinity for the request to find an available asset to complete the work until an available asset is found or the feasible resource pools are exhausted. According to embodiments of the present invention, determining which pools have an affinity for a request can be performed after ordering the resource pools in order of uniqueness adjusted utilization value or at a time prior to ordering the resource pools, such as before calculating the uniqueness of each resource pool.

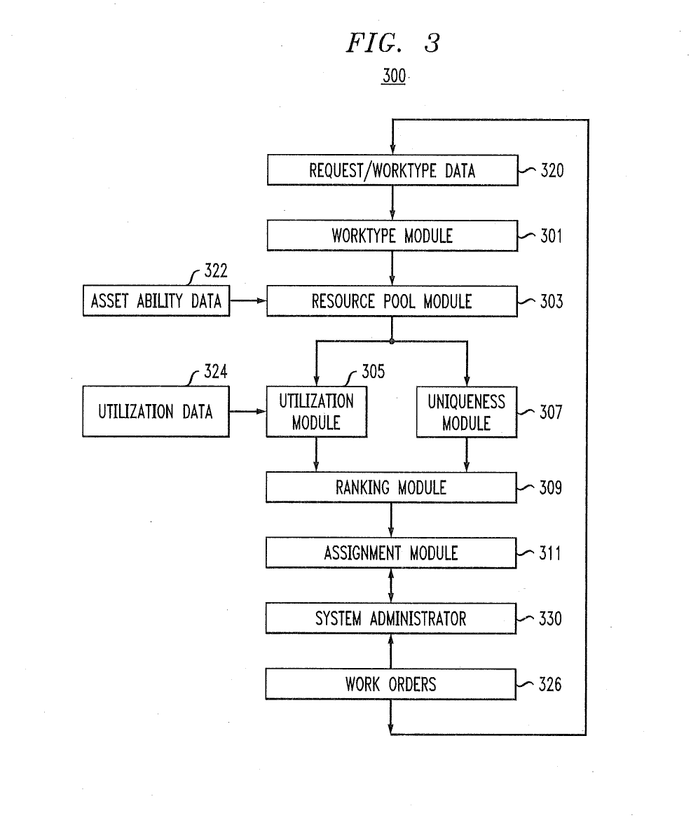

Referring to FIG. 3, which is a high-level diagram of a system for determining asset assignment in a service delivery environment according to an exemplary embodiment of the invention, the system 300 comprises a worktype module 301, a resource pool module 303, a utilization module, a uniqueness module, a ranking module and an assignment module 311. Referring to FIG. 3 in connection with FIGS. 1 and 2, according to an embodiment of the present invention, the worktype module 301 receives request/worktype data 320, which includes, for example, the types of services offered by the service provider, such as, for example, accounting, payroll, data management, computer type services, etc. The worktype module 301 processes the data 320 to define each worktype and identify a number of worktypes W. Processing the data may include, for example, categorizing the data 320. The worktype information is output to the resource pool module 303. The resource pool module uses the processed worktype data and asset ability data 322, including, for example, the skills/capabilities of the assets, to define asset resource pools and identify the number of resource pools N. According to an embodiment, the resource pool module uses the asset ability data 322 to determine affinity vectors for each asset as described above. Then, the resource pool module 303 analyzes the asset affinity vectors to define and identify the number of the asset resource pools.

The resource pool module 303 outputs the resource pool information, including the assets in each resource pool and the number of resource pools to the utilization and uniqueness modules 305 and 307. The uniqueness module 307 also receives the worktype data from the worktype module 301, which can be sent directly from the worktype module 301 or via the resource pool module 303 to the uniqueness module 307. As described above, for each request/worktype, the uniqueness module 307 counts the number of resource pools that can process a particular worktype, and defines the uniqueness of each worktype/request as 1/x, where x is the number of resource pools that can process a worktype. The uniqueness module 307 then calculates the uniqueness of each resource pool by summing the uniquenesses of each of the worktypes handled by the pool.

Using utilization data 324 collected for each of the resource pools, the utilization module 305 computes the utilization of each of the resource pools to a current time by calculating a total time period that assets from a resource pool have been used over an overall time period.

Using the output from the utilization and uniqueness modules 305 and 307, the ranking module 309 multiplies the resource pool uniqueness score by the utilization value to determine a uniqueness adjusted utilization value for each pool, and orders the resource pools in order of uniqueness adjusted utilization value.

According to an embodiment, a system administrator receiving a request for service, or a work order 326, inputs the work order information to an assignment module 311, and queries the assignment module 311 for a service asset that is capable of handling the request. The assignment module 311 analyzes the work order to determine which pools have an affinity for (i.e., are capable of handling) the request. The assignment module 311 assigns the work to the first ranked resource pool, and an asset in the first ranked resource pool, that has an affinity for the request. According to an embodiment, if no assets in the first ranked resource pool are available to complete the work order, the assignment module 311 will move the next ranked resource pool with an affinity for the request to find an available asset to complete the work order until an available asset is found or the feasible resource pools are exhausted.

As will be appreciated by one skilled in the art, aspects of the present invention may be embodied as a system, apparatus, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIGS. 1, 2 and 3 illustrate the architecture, functionality, and operation of possible implementations of systems, methods, and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

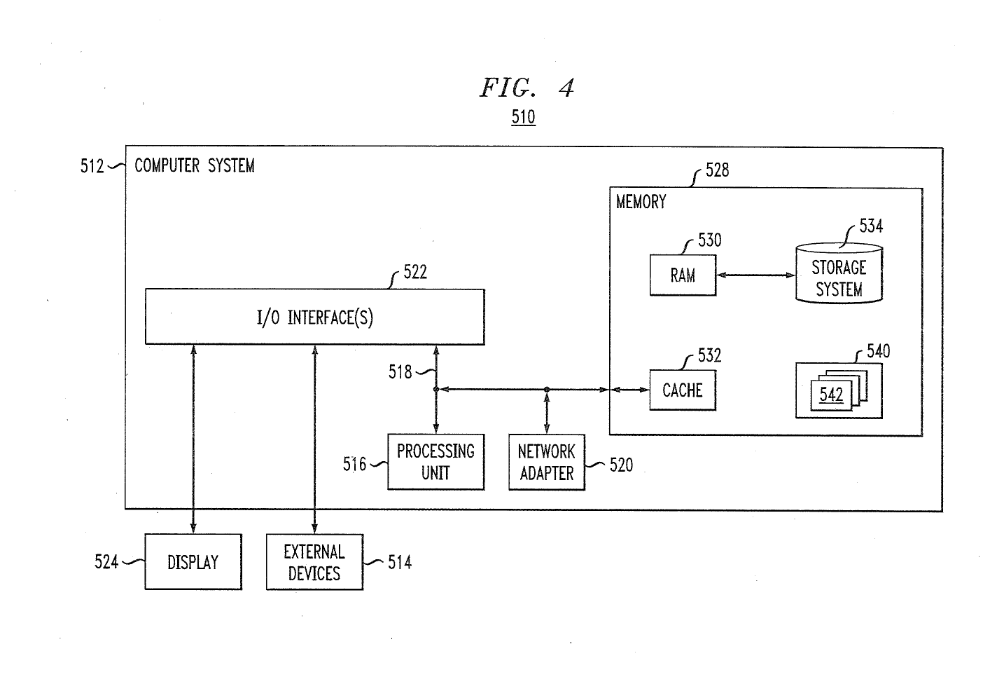

One or more embodiments can make use of software running on a general-purpose computer or workstation. With reference to FIG. 4, in a computing node 510 there is a computer system/server 512, which is operational with numerous other general purpose or special purpose computing system environments or configurations. Examples of well-known computing systems, environments, and/or configurations that may be suitable for use with computer system/server 512 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 512 may be described in the general context of computer system executable instructions, such as program modules, being executed by a computer system. Generally, program modules may include routines, programs, objects, components, logic, data structures, and so on that perform particular tasks or implement particular abstract data types. Computer system/server 512 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 512 in computing node 510 is shown in the form of a general-purpose computing device. The components of computer system/server 512 may include, but are not limited to, one or more processors or processing units 516, a system memory 528, and a bus 518 that couples various system components including system memory 528 to processor 516.

The bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system/server 512 typically includes a variety of computer system readable media. Such media may be any available media that is accessible by computer system/server 512, and it includes both volatile and non-volatile media, removable and non-removable media.

The system memory 528 can include computer system readable media in the form of volatile memory, such as random access memory (RAM) 530 and/or cache memory 532. The computer system/server 512 may further include other removable/non-removable, volatile/nonvolatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 518 by one or more data media interfaces. As depicted and described herein, the memory 528 may include at least one program product having a set (e.g., at least one) of program modules that are configured to carry out the functions of embodiments of the invention. A program/utility 540, having a set (at least one) of program modules 542, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 542 generally carry out the functions and/or methodologies of embodiments of the invention as described herein.

Computer system/server 512 may also communicate with one or more external devices 514 such as a keyboard, a pointing device, a display 524, etc., one or more devices that enable a user to interact with computer system/server 512, and/or any devices (e.g., network card, modem, etc.) that enable computer system/server 512 to communicate with one or more other computing devices. Such communication can occur via Input/Output (I/O) interfaces 522. Still yet, computer system/server 512 can communicate with one or more networks such as a local area network (LAN), a general wide area network (WAN), and/or a public network (e.g., the Internet) via network adapter 520. As depicted, network adapter 520 communicates with the other components of computer system/server 512 via bus 518. It should be understood that although not shown, other hardware and/or software components could be used in conjunction with computer system/server 512. Examples, include, but are not limited to: microcode, device drivers, redundant processing units, external disk drive arrays, RAID systems, tape drives, and data archival storage systems, etc.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

We claim:

1. A system for determining asset assignment in a service delivery environment, comprising:
a worktype module capable of processing worktype data to define a plurality of worktypes and identify a number of the worktypes;
a resource pool module connected with the worktype module, wherein the resource pool module receives the processed worktype data from the worktype module and is capable of using the processed worktype data and asset ability data to define a plurality of asset resource pools and identify a number of the resource pools;
a uniqueness module connected with the resource pool module, wherein the uniqueness module receives resource pool data from the resource pool module and is capable of calculating a uniqueness of each resource pool;
a utilization module connected with the resource pool module, wherein the utilization module receives the resource pool data from the resource pool module and is capable of computing a utilization of each resource pool; and
a ranking module connected with the utilization and uniqueness modules, wherein the ranking module receives the uniqueness and the utilization of each resource pool from the uniqueness and utilization modules, and determines a uniqueness adjusted utilization value for each resource pool, wherein one or more of the modules are implemented on a computer system comprising a memory and at least one processor coupled to the memory.

2. The system of claim 1, wherein the resource pool module uses the asset ability data to determine affinity vectors for each asset.

3. The system of claim 2, wherein the resource pool module analyzes the asset affinity vectors to define and identify the number of the asset resource pools.

4. The system of claim 1, wherein the resource pool data includes assets in each resource pool and the number of resource pools.

5. The system of claim 1, wherein the uniqueness module receives the processed worktype data, and wherein, for each worktype, the uniqueness module counts a number of resource pools that can process the worktype, and defines a uniqueness of each worktype.

6. The system of claim 5, wherein the uniqueness module defines the uniqueness of each worktype as 1/x, where x is the number of resource pools that can process the worktype.

7. The system of claim 5, wherein the uniqueness module calculates the uniqueness of each resource pool by summing the uniquenesses of each worktype handled by a resource pool.

8. The system of claim 1, wherein the utilization module uses utilization data collected for each resource pool to compute the utilization of each resource pool to a current time.

9. The system of claim 1, wherein the utilization of each resource pool is computed by calculating a total time period that assets from a resource pool have been used over an overall time period.

10. The system of claim 1, wherein the ranking module determines the uniqueness adjusted utilization value for each pool by multiplying the uniqueness of a resource pool by the utilization of the resource pool.

11. The system of claim 1, wherein the ranking module orders the resource pools in order of uniqueness adjusted utilization value.

12. The system of claim 11, further comprising an assignment module capable of determining which of the resource pools have an affinity for a work request, and assigning the work request to a first ranked resource pool that has the affinity for the work request.

13. An article of manufacture comprising a computer readable storage medium comprising program code tangibly embodied thereon, which when executed by a computer, performs method steps for asset assignment in a service delivery environment, the method steps comprising:
identifying a number of worktypes;
defining a plurality of asset resource pools and identifying a number of the resource pools;
calculating a uniqueness of each resource pool;
computing a utilization of each resource pool; and
determining a uniqueness adjusted utilization value for each resource pool.

14. An apparatus for determining asset assignment in a service delivery environment, comprising:
a memory; and
a processor coupled to the memory and configured to execute code stored in the memory for:
identifying a number of worktypes;
defining a plurality of asset resource pools and identifying a number of the resource pools;
calculating a uniqueness of each resource pool;
computing a utilization of each resource pool; and
determining a uniqueness adjusted utilization value for each resource pool.
